(19) United States
(12) Patent Application Publication
(10) Pub. No.: US 2013/0024792 A1
(43) Pub. Date: Jan. 24, 2013

(54) INFORMATION PROCESSING DEVICE, INFORMATION PROCESSING METHOD, AND PROGRAM

(71) Applicants: Masaaki Isozu, Tokyo (JP); Tomohiko Sakamoto, Tokyo (JP); Kazuhiro Watanabe, Tokyo (JP)

(72) Inventors: Masaaki Isozu, Tokyo (JP); Tomohiko Sakamoto, Tokyo (JP); Kazuhiro Watanabe, Tokyo (JP)

(73) Assignee: Sony Corporation, Tokyo (JP)

(21) Appl. No.: 13/546,598

(22) Filed: Jul. 11, 2012

(30) Foreign Application Priority Data
Jul. 19, 2011 (JP) 2011-157973

(51) Int. Cl. G06F 3/048

(52) U.S. Cl. 715/764

(57) ABSTRACT

Provided is an information processing device including a first detection unit configured to detect a movement of an operation device having a user interface that can be operated by a user, a second detection unit configured to detect a user operation on the user interface, and a processing unit configured to perform a process based on one of a detection result obtained by the first detection unit or a detection result obtained by the second detection unit. The processing unit, when, while performing a process based on a detection result obtained by one of the first detection unit or the second detection unit, a detection result obtained by the other detection unit is detected, selectively changes content of the process being performed based on the detection result obtained by the one of the detection units, based on the detection result obtained by the other detection unit.

### BACKGROUND

The present disclosure relates to an information processing device, an information processing method, and a program.

In recent years, devices having touch panels, which can display display screens and allow user operations to be performed on the display screens, have come into widespread use, like communication devices such as smartphones, for example. Among such devices is a device that can detect one or more user operations (hereinafter also referred to as a “multi-touch operation”) on the display screen. Herein, a multi-touch user interface that allows a multi-touch operation to be performed thereon is becoming an important technology for providing a more intuitive operation to the user.

Further, a technology related to the selection of an object based on an input to the touch panel is also developed. Examples of the technology related to the selection of an object based on an input to the touch panel include the technology disclosed in JP 2011-34151A.

### SUMMARY

However, even when a user uses a device that adopts a multi-touch user interface, it would be difficult for the user to perform a plurality of operations in parallel. For example, in order to move selected icons (or an icon group, hereinafter the same) and copy non-selected icons, the user should, after moving the selected icons, perform the copy by selecting the other icons (which correspond to the non-selected icons). Accordingly, even when a multi-touch user interface is used, it is not always the case that the operability for the user can be sufficiently improved.

The present disclosure provides an information processing device, an information processing method, and a program that are novel and improved and that can improve the operability for a user.

According to an embodiment of the present disclosure, there is provided an information processing device including a first detection unit configured to detect a movement of an operation device having a user interface that can be operated by a user, a second detection unit configured to detect a user operation on the user interface, and a processing unit configured to perform a process based on one of a detection result obtained by the first detection unit or a detection result obtained by the second detection unit. The processing unit, when, while performing a process based on a detection result obtained by one of the first detection unit or the second detection unit, a detection result obtained by the other detection unit is detected, selectively changes content of the process being performed based on the detection result obtained by the one of the detection units, based on the detection result obtained by the other detection unit.

According to another embodiment of the present disclosure, there is provided an information processing method including detecting a movement of an operation device having a user interface that can be operated by a user, detecting a user operation on the user interface, and performing a process based on one of a detection result of the movement of the operation device or a detection result of the user operation. The step of performing the process includes, when, while performing a process based on one of the detection result of the movement of the operation device or the detection result of the user operation, the other detection result is detected, selectively changing content of the process being performed based on the one of the detection results, based on the other detection result.

According to another embodiment of the present disclosure, there is provided a program for causing a computer to execute detecting a movement of an operation device having a user interface that can be operated by a user, detecting a user operation on the user interface, and performing a process based on one of a detection result of the movement of the operation device or a detection result of the user operation. The step of performing the process includes, when, while performing a process based on one of the detection result of the movement of the operation device or the detection result of the user operation, the other detection result is detected, selectively changing content of the process being performed based on the one of the detection results, based on the other detection result.

According to the embodiments of the present disclosure described above, the operability for a user can be improved.

### BRIEF DESCRIPTION OF THE DRAWINGS

FIG. 1 is an explanatory diagram illustrating a process in accordance with an information processing method in accordance with an embodiment of the present disclosure;

FIG. 2 is an explanatory diagram illustrating a process in accordance with an information processing method in accordance with an embodiment of the present disclosure;

FIG. 3A is an explanatory diagram illustrating a process in accordance with an information processing method in accordance with an embodiment of the present disclosure;

FIG. 3B is an explanatory diagram illustrating a process in accordance with an information processing method in accordance with an embodiment of the present disclosure;

FIG. 4 is an explanatory diagram illustrating a process in accordance with an information processing method in accordance with an embodiment of the present disclosure;

FIG. 5 is an explanatory diagram illustrating a process in accordance with an information processing method in accordance with an embodiment of the present disclosure;

FIG. 6 is an explanatory diagram illustrating an example of a method of determining selected objects with an information processing device in accordance with an embodiment of the present disclosure;

FIG. 7 is a flowchart showing an example of a process performed by an information processing device in accordance with an embodiment of the present disclosure;

FIG. 8 is a block diagram showing an exemplary configuration of an information processing device in accordance with an embodiment of the present disclosure; and

FIG. 9 is an explanatory diagram showing an exemplary hardware configuration of an information processing device in accordance with an embodiment of the present disclosure.

### DETAILED DESCRIPTION OF THE EMBODIMENTS

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, description will be made in the following order.

1. Information Processing Method in accordance with Embodiment of the Present Disclosure

2. Information Processing Device in accordance with Embodiment of the Present Disclosure

3. Program in accordance with Embodiment of the Present Disclosure

### Information Processing Method in Accordance with Embodiment of the Present Disclosure

Prior to the description of the configuration of an information processing device in accordance with this embodiment, an information processing method in accordance with this embodiment will be described. Hereinafter, description will be made on the assumption that the information processing device in accordance with this embodiment performs a process in accordance with the information processing method in accordance with this embodiment.

### Summary of Information Processing Method in Accordance with this Embodiment

As described above, even when a user performs an operation using a multi-touch user interface, it would be difficult for the user to perform a plurality of operations in accordance with each process executed by a device in parallel.

Thus, the information processing device in accordance with this embodiment detects a movement of an operation device having a user interface that can be operated by a user, and a user operation on the user interface (a detection process). Then, the information processing device in accordance with this embodiment performs, based on the detection result of the movement of the operation device and the detection result of the user operation, a process corresponding to each detection result (an execution process).

Examples of the operation device in accordance with this embodiment include the information processing device in accordance with this embodiment. When the operation device is the information processing device in accordance with this embodiment, it follows that the information processing device in accordance with this embodiment detects each of the movement of the information processing device and a user operation.

When the operation device is the information processing device in accordance with this embodiment, the information processing device in accordance with this embodiment includes various sensors such as, for example, an acceleration sensor, a gyro sensor, a proximity sensor, or a GPS (Global Positioning System) device, and detects a movement of the operation device (i.e., the information processing device) based on the detection value of such sensor. By detecting a movement of the operation device as described above, the information processing device in accordance with this embodiment can detect a physical operation on the operation device such as, for example, “tilting the operation device” and “shaking the operation device.” The information processing device in accordance with this embodiment may further detect an operation amount of a physical operation on the operation device. In addition, the information processing device in accordance with embodiment can, by detecting a movement of the operation device as described above, perform a process based on a change in the position (place) where the operation device is located or a process based on information corresponding to the position where the operation device is located (e.g., information on the weather at the position).

When the operation device is the information processing device in accordance with this embodiment, the information processing device in accordance with this embodiment detects, based on a signal in accordance with a user operation generated in response to a user operation on each user interface, the user operation on the user interface. Herein, examples of the user interface in accordance with this embodiment include a user interface that uses a touch panel capable of displaying a display screen and allowing a user operation to be performed on the display screen, and a user interface that uses a physical operation device such as a button. By detecting a user operation on the user interface as described above, the information processing device in accordance with this embodiment can detect a user operation such as, for example, a “touch operation on the touch panel” or a “button pressing operation.” Further, the information processing device in accordance with this embodiment may further detect an operation amount of a user operation on the user interface.

Note that the operation device in accordance with this embodiment is not limited to the aforementioned example. For example, the operation device in accordance with this embodiment may be an external device (i.e., an external operation device) of the information processing device in accordance with this embodiment. When the operation device is an external operation device, the information processing device in accordance with this embodiment performs the aforementioned detection process and the aforementioned execution process by performing wire/wireless communication with the external operation device.

For example, when the operation device is an external operation device, the information processing device in accordance with this embodiment receives from the external operation device detection values of various sensors such as an acceleration sensor of the external operation device as well as a signal in accordance with a user operation on a user interface of the external operation device. In addition, the information processing device in accordance with this embodiment detects, based on the received detection values and the signal, each of a movement of the operation device (i.e., the external device) and the user operation (a detection process). Then, the information processing device in accordance with this embodiment performs, based on the detection result of the movement of the operation device (i.e., the external device) and the detection result of the user operation, performs a process corresponding to each detection result (an execution process).

As described above, the information processing device in accordance with this embodiment performs, by detecting different types of operations: a physical operation on the operation device and a user operation on the user interface, a process corresponding to the detected operations. Herein, a physical operation on the operation device and a user operation on the user interface can be performed in parallel at the same timing, and thus are not exclusive operations. Accordingly, as the information processing method in accordance with this embodiment causes the information processing device in accordance with this embodiment to execute a plurality of processes at the same timing, it becomes possible for the user to perform a plurality of operations in parallel. Thus, the operability for the user can be improved.

In addition, the information processing device in accordance with this embodiment, when, while performing a process based on one of the detection result of the movement of the operation device or the detection result of the user operation, the other detection result is detected, selectively changes the content of the process being performed based on the one of the detection results, based on the other detection result (an execution process).

Herein, examples of the changing of the content of the process being performed based on one of the detection results with the information processing device in accordance with this embodiment include a process of interrupting or stopping the process being executed based on the one of the detection results. In addition, examples of the selective changing of the content of the process with the information processing device in accordance with this embodiment include determining if the other detection result is related to an object that is a processing target of the process being performed based on the one of the detection results, and, if it is, changing the content of the process being performed based on the one of the detection results. A specific example of the selective changing of the content of the process with the information processing device in accordance with this embodiment will be described later.

The information processing device in accordance with this embodiment does not only perform a process corresponding to each of different types of detected operations, but also, when, while performing a process based on one of the detection results, the other detection result is detected, selectively changes the content of the process being performed based on the one of the detection results. That is, using the information processing device in accordance with this embodiment, a user can control execution of processes in the information processing device by combining the different types of operations. Accordingly, the information processing device in accordance with this embodiment can further improve the operability for the user.

Thus, the information processing device in accordance with this embodiment can, by performing the detection process (I) and the execution process (II) shown above, for example, further improve the operability for the user.

### Specific Example of Process in Accordance with Information Processing Method in Accordance with this Embodiment

Next, a process in accordance with the information processing method in accordance with this embodiment will be described more specifically. Hereinafter, description will be made on the assumption that the information processing device in accordance with this embodiment (hereinafter also referred to as an “information processing device 100”) performs a process in accordance with the information processing method in accordance with this embodiment. In addition, hereinafter, description will be made mainly of an example in which the information processing device 100 is an operation device.

Hereinafter, description will be made of an example in which the information processing device 100 performs a process on selected objects (or an object group, hereinafter the same) and a process on non-selected objects that are not selected, based on a physical operation on the operation device and a user operation on the user interface. Note that a process executed in accordance with the detection result in the information processing device 100 in accordance with this embodiment is not limited to the process on the selected objects or non-selected objects. For example, the information processing device 100 can execute various processes such as a search process or a content data playback process in accordance with the detection result.

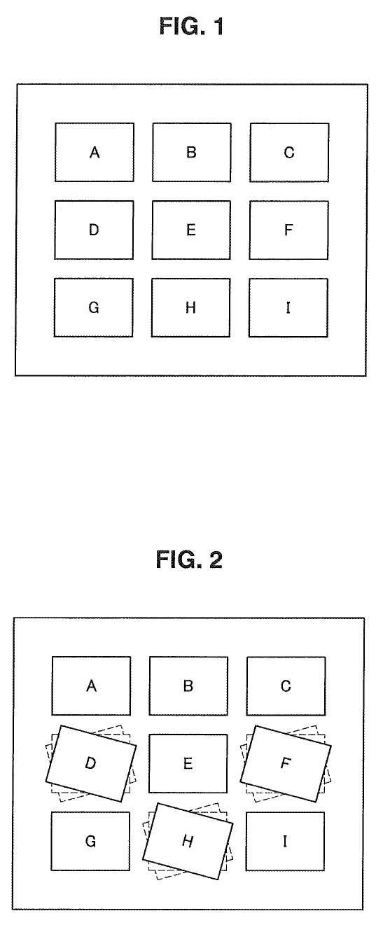

FIGS. 1 to 5 are explanatory diagrams illustrating a process in accordance with the information processing method in accordance with this embodiment. Herein, FIGS. 1 to 4 show examples of a display screen on which nine types of objects: A to I are displayed. FIG. 1 shows a state in which a user operation is not performed (an initial state) and FIGS. 2 to 4 each show an example of a state after a user operation has started.

FIG. 5 shows an example of a relationship between each of selected objects (which correspond to a selected group shown in FIG. 5) and non-selected objects (which correspond to a non-selected group shown in FIG. 5); a physical operation on the operation device (which corresponds to a physical operation shown in FIG. 5); and a user operation on the user interface (which corresponds to a UI operation shown in FIG. 5). For example, as shown in FIG. 5, the information processing device 100 performs a process so that a combination of selected objects and an executable operation therefore differs from a combination of non-selected objects and an executable operation therefore. Hereinafter, description will be made of an example in which a user operation on the user interface can be performed on selected objects and a physical operation on the operation device can be performed on non-selected objects. It is needless to mention that a physical operation on the operation device can be performed on selected objects and a user operation on the user interface can be performed on non-selected objects.

For example, upon detecting a user operation indicating that the user has selected the objects A, B, C, E, G, and I, the information processing device 100 visually shakes the objects D, F, and H that are non-selected objects (FIG. 2).

Note that the method of determining the selected objects with the information processing device 100 is not limited to the method of detecting a user operation indicating that specific objects have been selected. For example, when additional information (e.g., meta information) serving as an index for selection is added to objects, the information processing device 100 may, upon detecting a user operation indicating that selection should be performed, determine the selected objects based on the additional information of each object.

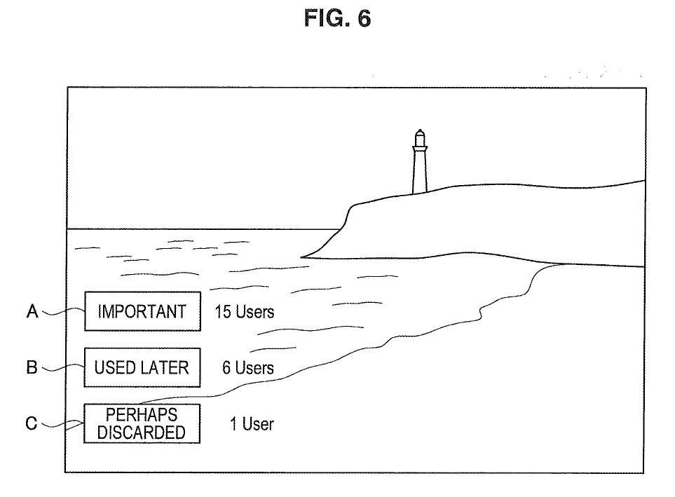

FIG. 6 is an explanatory diagram illustrating an example of a method of determining selected objects with the information processing device 100 in accordance with this embodiment. Herein, FIG. 6 shows a case in which objects are still images. In addition, FIG. 6 shows an example in which content A to C of additional information are visually shown. The content of the additional information of the objects such as those shown in FIG. 6 are updated by a user of the information processing device 100, a user of an external device connected to the information processing device 100 via a network or the like, for example.

The information processing device 100, upon detecting a user operation indicating that selection should be performed, refers to the additional information set on the objects. Then, the information processing device 100, if the number of users corresponding to “important” (symbol A shown in FIG. 6) and/or “used later” (symbol B shown in FIG. 6) indicated by the additional information is greater than or equal to a predetermined number (or if the number of such users is greater than the predetermined number), for example, determines that the objects corresponding to the additional information are the selected objects.

The information processing device 100 determines the selected objects based on a user operation indicating that specific objects have been selected and the additional information of each object, and visually shakes the non-selected objects such as those shown in FIG. 2.

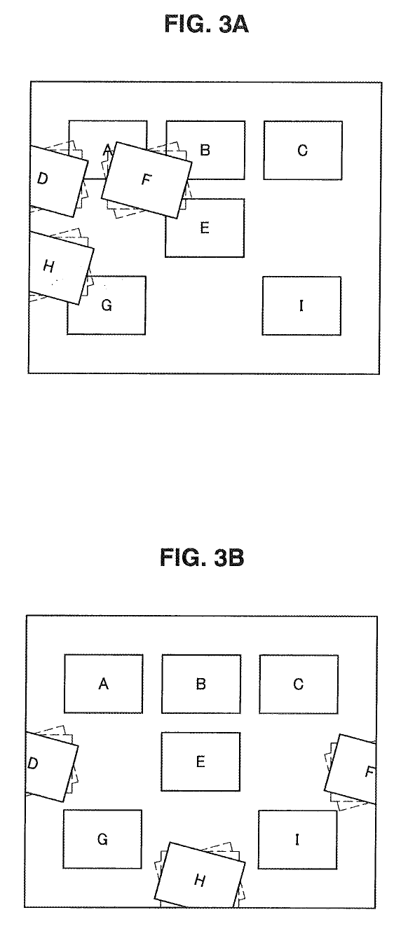

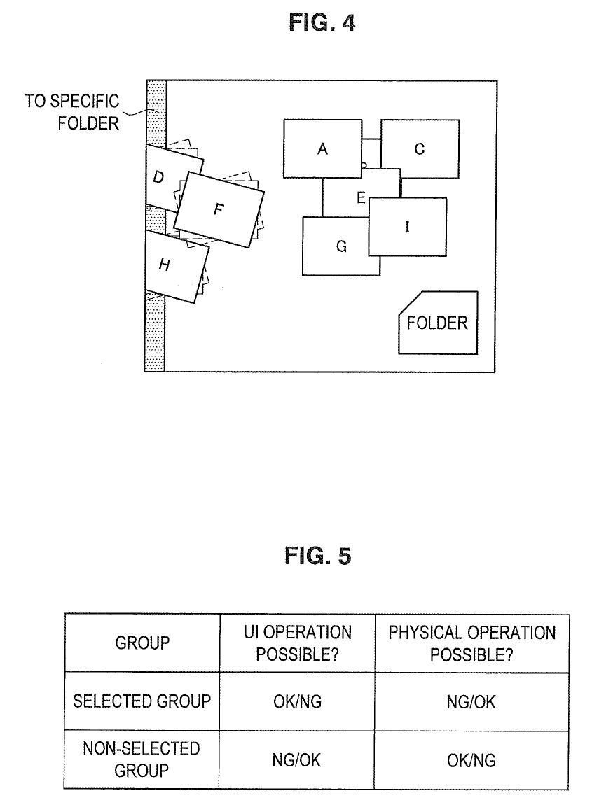

When a movement of the operation device is detected in the state shown in FIG. 2, the information processing device 100 moves the non-selected objects based on the detection result of the movement of the operation device (an example of an execution process). For example, upon detecting that the operation device is tilted to the left side, the information processing device 100 moves the objects D, F, and H, which are the non-selected objects, to the left side of the screen as shown in FIG. 3A, for example. Meanwhile, upon detecting that the operation device is shaken, the information processing device 100 moves the objects D, F, and H, which are the non-selected objects, such that they are dispersed as shown in FIG. 3B, for example. Herein, as shown in FIG. 4, for example, the information processing device 100 can correlate a particular direction of the display screen (the left side of the display screen in the example shown in FIG. 4) with a process performed. In the example shown in FIG. 4, the moved objects are moved toward the left side of the display screen, whereby the objects move to a specific folder.

Note that the method of moving the non-selected objects based on the detection result of the movement of the operation device in accordance with this embodiment is not limited to the example shown in FIGS. 3A to 4. For example, the information processing device 100 can realize a movement of the objects D, F, H, which are the non-selected objects shown in FIG. 2, by enlarging or shrinking the non-selected objects. In the case of enlarging the objects, the information processing device 100, when the display size of the objects has become greater than or equal to a predetermined size (or has become greater than the predetermined size), stops the display of the objects on the display screen. In the case of shrinking the objects, the information processing device 100, when the display size of the objects has become smaller than or equal to a predetermined size (or has become smaller than the predetermined size), stops the display of the objects on the display screen.

Meanwhile, when a user operation on the user interface is detected in the state shown in FIG. 2, the selected objects are moved based on the detection result of the user operation (an example of an execution process). For example, when a swipe operation of a user is detected, the selected objects are moved in a direction corresponding to the operation direction of the detected swipe operation.

The information processing device 100 realizes a movement of each of the selected objects and the non-selected objects based on each of the detection result of the movement of the operation device and the detection result of the user operation on the user interface as described above, for example. Herein, a user can perform a physical operation on the operation device and a user operation on the user interface at the same timing in parallel. When a physical operation on the operation device and a user operation are performed in parallel, the information processing device 100 performs movement of the selected objects and movement of the non-selected objects in parallel based on the detection result of the movement of the operation device and the detection result of the user operation.

Thus, as the information processing device 100 allows a user to perform a plurality of operations in parallel to cause the information processing device 100 to execute a plurality of processes at the same timing, it is possible to further improve the operability for the user.

In addition, the information processing device 100, when, while performing a process based on one of the detection result of the movement of the operation device or the detection result of the user operation as described above, the other detection result is detected, selectively changes the content of the process being performed based on the one of the detection results, based on the other detection result.

For example, the information processing device 100, when, while moving the non-selected objects based on a detection result of a movement of the operation device, a user operation on the user interface is detected, determines if the detected user operation is an operation related to the process of moving the non-selected objects (an example of a process being performed based on a detection result of a movement of the operation device). Then, if the information processing device 100 has determined that the detected user operation is an operation related to the process of moving the non-selected objects, the information processing device 100 interrupts or stops the movement of the non-selected objects. Meanwhile, if the information processing device 100 has not determined that the detected user operation is an operation related to the process of moving the non-selected objects, the information processing device 100 performs a process corresponding to the detected user operation.

Herein, examples of a method of determining, with the information processing device 100 in accordance with this embodiment, if the detected user operation is an operation related to the process of moving the non-selected objects (an example of a process being performed based on a detection result of a movement of the operation device) include a method of determining if the detected user operation has been performed on the non-selected objects that are moving. For example, the information processing device 100, upon detecting a touch operation on the coordinates in an area of the display screen corresponding to the non-selected objects that are moving, determines that the detected user operation is an operation related to the non-selected objects. It is needless to mention that the method of determining if the detected user operation is an operation related to a process being performed based on a detection result of a movement of the operation device in accordance with this embodiment is not limited to the aforementioned example.

The information processing device 100, when, while performing a process based on a detection result of a movement of the operation device, a user operation is detected, selectively changes the content of the process being performed based on the detection result of the movement of the operation device, based on the detection result of the user operation.

Meanwhile, for example, the information processing device 100, when, while moving the selected objects based on a detection result of a user operation on the user interface, a movement of the operation device is detected, determines if the detected movement of the operation device is an operation related to the process of moving the non-selected objects (an example of a process being performed based on a detection result of a user operation). Then, if the information processing device 100 has determined that the detected user operation is an operation related to the process of moving the selected objects, the information processing device 100 interrupts or stops the movement of the selected objects. Meanwhile, if the information processing device 100 has not determined that the detected user operation is an operation related to the process of moving the selected objects, the information processing device 100 performs a process corresponding to the detected movement of the operation device.

Herein, examples of the method of determining, with the information processing device 100 in accordance with this embodiment, if the detected user operation is an operation related to the process of moving the selected objects (an example of a process being performed based on a detection result of a user operation on the interface) include a method of performing determination based on if the detected movement of the operation device has been performed on the selected objects that are moving. For example, the information processing device 100, upon detecting a movement of the operation device in a direction opposite to the movement direction of the selected objects that are moving, determines that the detected movement of the operation device is an operation related to the selected objects. It is needless to mention that the method of determining if the detected user operation is an operation related to a process being performed based on the detection result of the user operation in accordance with this embodiment is not limited to the aforementioned example.

The information processing device 100, when, while performing a process based on a detection result of a user operation as described above, for example, a movement of the operation device is detected, selectively changes the content of the process being performed based on the detection result of the user operation, based on the detection result of the movement of the operation device.

The information processing device 100, when, while performing a process based on one of a detection result of a movement of the operation device or a detection result of a user operation as described above, for example, the other detection result is detected, selectively changes the content of the process being performed based on the one of the detection results, based on the other detection result. Accordingly, by using the information processing device 100, a user can control execution of processes in the information processing device 100 by mutually combining different types of operations.

Thus, the information processing device 100 can further improve the operability for the user.

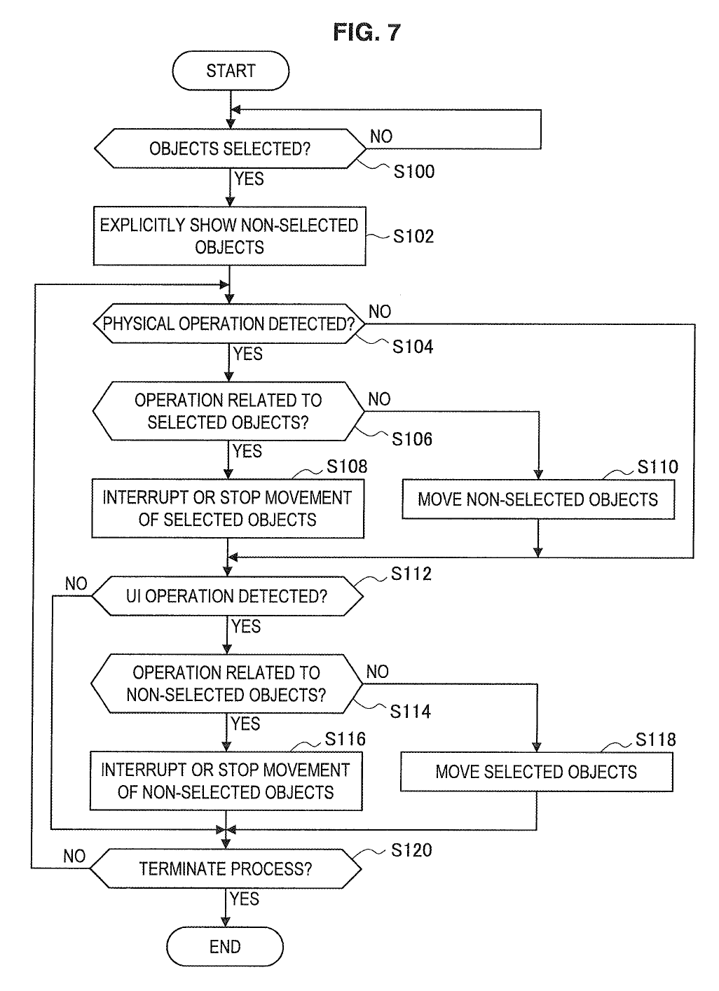

Next, processes performed by the information processing device 100 in accordance with an example of a movement of the selected objects or a movement of the non-selected objects shown in FIGS. 1 to 6 will be described more specifically. FIG. 7 is a flowchart showing an example of a process performed by the information processing device 100 in accordance with this embodiment. In FIG. 7, a physical operation on the operation device detected when a movement of the operation device is detected is simply referred to as a “physical operation” and a user operation on the user interface is referred to as a “UI operation.”

Although FIG. 7 shows an example in which a process related to a user operation on the user interface is performed after a process related to a physical operation on the operation device is performed for descriptive purposes, the processes of the information processing device 100 in accordance with this embodiment are not limited thereto. As described above, a user who uses the information processing device 100 in accordance with this embodiment can perform a physical operation on the operation device and a user operation on the user interface at the same timing in parallel. Accordingly, the information processing device 100 may perform a process related to a physical operation on the operation device after a process related to a user operation on the user interface is performed, or perform a process related to a physical operation on the operation device and a process related to a user operation in parallel.

The information processing device 100 determines if objects are selected (S100). If objects are not determined to be selected in step S100, the information processing device 100 does not advance the process until when objects are determined to be selected.

If objects are determined to be selected in step S100, the information processing device 100 explicitly shows non-selected objects (S102). Herein, the information processing device 100 explicitly shows non-selected objects by visually shaking the non-selected objects as shown in FIG. 2, for example. It is needless to mention that the method of explicitly showing the non-selected objects in accordance with this embodiment is not limited to the method of virtually shaking the non-selected objects as shown in FIG. 2.

After the process in step S102 is performed, the information processing device 100 determines if a physical operation is detected (S104). Herein, the information processing device 100 determines that a physical operation is detected if a movement of the operation device is detected. If a physical operation is not determined to be detected in step S104, the information processing device 100 performs a process in step S112 described below.

If a physical operation is determined to be detected in step S104, the information processing device 100 determines if the detected physical operation is an operation related to the selected objects (S106). Herein, the information processing device 100, if there exist selected objects that are moving and the information processing device 100 detects a movement of the operation device in a direction opposite to the movement direction of the selected objects, determines that the detected physical operation is an operation related to the selected objects.

If the detected physical operation is determined to be an operation related to the objects selected in step S106, the information processing device 100 interrupts or stops the movement of the selected objects (S108).

If the detected physical operation is not determined to be an operation related to the objects selected in step S106, the information processing device 100 moves the non-selected objects (S110). Herein, the information processing device 100 may change the way to move the non-selected objects based on the detected movement amount of the operation device. For example, when the information processing device 100 detects a tilt of the operation device as a movement of the operation device, the information processing device 100 changes the movement speed, the movement amount, movement acceleration, and the like in accordance with an angle in the horizontal direction (an example of the movement amount of the operation device).

By changing the way to move the non-selected objects based on the detected movement amount of the operation device as described above, the information processing device 100 can realize movement of the objects in accordance with the way to tilt the operation device by the user. In addition, when the way to move the objects is changed based on the detected movement amount of the operation device as described above, for example, the inertia action of the objects can be realized. Thus, the information processing device 100 can provide a more comfortable operation to the user.

After the process in step S108 or the process in step S110 is performed, the information processing device 100 determines if a UI operation is detected (S112). Herein, the information processing device 100, upon detecting a user operation on the user interface, for example, determines that a UI operation has been detected. If a UI operation is not determined to be detected in step S112, the information processing device 100 performs a process in step S120 described below.

If a UI operation is determined to be detected in step S112, the information processing device 100 determines if the detected UI operation is an operation related to the non-selected objects (S114). Herein, the information processing device 100, if there exist non-selected objects that are moving and the information processing device 100 detects an operation on the coordinates in an area of the display screen corresponding to the non-selected objects, for example, determines that the detected UI operation is an operation related to the non-selected objects.

If the detected UI operation is determined to be an operation related to the non-selected objects in step S114, the information processing device 100 interrupts or stops the movement of the non-selected objects (S116).

Meanwhile, if the detected UI operation is not determined to be an operation related to the non-selected objects in step S114, the information processing device 100 moves the selected objects (S118).

If an UI operation is not determined to be detected in step S112, or if the process in step S116 or the process in step S118 is performed, the information processing device 100 determines if the process should be terminated (S120). Herein, the information processing device 100, if all of the executed processes (which correspond to the movement of the selected objects and/or the movement of the non-selected objects in the example shown in FIG. 7) have terminated, or if a specific user operation for forcibly terminating the process is detected, determines that the process should be terminated.

If it is not determined that the process should be terminated in step S120, the information processing device 100 repeats the process of from step S104. Meanwhile, if it is determined that the process should be terminated in step S120, the information processing device 100 terminates the process shown in FIG. 7.

The information processing device 100, by performing the process shown in FIG. 7, for example, moves the selected objects and/or non-selected objects based on the detection result of the movement of the operation device and the detection result of the user operation. It is needless to mention that the process related to the example of the movement of the selected objects and the movement of the non-selected objects in the information processing device 100 in accordance with this embodiment is not limited to the process shown in FIG. 7.

### Information Processing Device in Accordance with this Embodiment

Next, an exemplary configuration of the information processing device 100 in accordance with this embodiment that can perform a process in accordance with the aforementioned information processing method in accordance with this embodiment will be described.

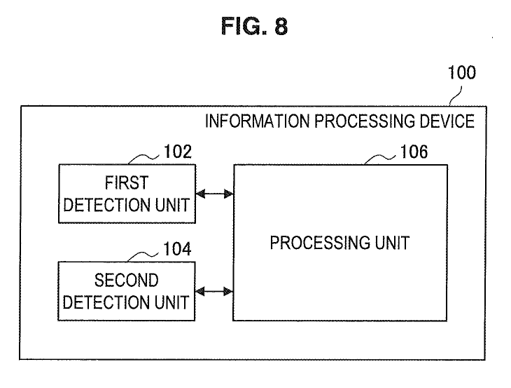

FIG. 8 is a block diagram showing an exemplary configuration of the information processing device 100 in accordance with this embodiment. The information processing device 100 includes, for example, a first detection unit 102, a second detection unit 104, and a processing unit 106.

In addition, the information processing device 100 may include, for example, a control unit (not shown), ROM (Read Only Memory; not shown), RAM (Random Access Memory; not shown), a storage unit (not shown), an operation unit that can be operated by a user (not shown), a display unit that displays various screens on the display screen (not shown), a communication unit (not shown) for communicating with an external device, and the like. The information processing device 100 connects each of the aforementioned components with a bus as a data transmission channel, for example.

Herein, the control unit (not shown) includes, for example, a MPU (Micro Processing Unit), various processing circuits, and the like, and controls the entire information processing device 100. In addition, the control unit (not shown) may serve as the first detection unit 102 (or a part of the first detection unit 102), the second detection unit 104 (or a part of the second detection unit 104), and the processing unit 106.

The ROM (not shown) stores control data such as programs and operation parameters used by the control unit (not shown). The RAM (not shown) temporarily stores programs executed by the control unit (not shown).

The storage unit (not shown) is a storage means of the information processing device 100, and stores various data such as applications, for example. Herein, the storage unit (not shown) may be, for example, a magnetic recording medium such as a hard disk or nonvolatile memory such as EEPROM (Electrically Erasable and Programmable Read Only Memory) or flash memory. In addition, the storage unit (not shown) may be removable from the information processing device 100.

The operation unit (not shown) may be, for example, a button, a direction key, a rotary selector such as a jog dial, or a combination of them. The information processing device 100 may connect to, for example, an operation input device (e.g., a keyboard or a mouse) as an external device of the information processing device 100.

The display unit (not shown) may be, for example, a liquid crystal display (LCD) or an organic EL display (also referred to as an organic ElectroLuminescence display or an OLED display (Organic Light Emitting Diode display)). Alternatively, the display unit (not shown) may be a device that can display information and can be operated by a user such as a touch screen, for example. Further, the information processing device 100 can connect to a display device (e.g., an external display) as an external device of the information processing device 100 regardless of whether it has a display unit (not shown) or not.

The communication unit (not shown) is a communication means of the information processing device 100, and performs wire or wireless communication with an external device via a network (or directly). Herein, the communication unit (not shown) may be, for example, a communication antenna and an RF (Radio Frequency) circuit (wireless communication); an IEEE 802.15.1 port and a transmitting/receiving circuit (wireless communication); an IEEE802.11b port and a transmitting/receiving circuit (wireless communication); a LAN (Local Area Network) terminal and a transmitting/receiving circuit (wire communication); or the like. In addition, the network in accordance with this embodiment may be, for example, a wire network such as a LAN or WAN (Wide Area Network), a wireless network such as a wireless LAN (WLAN: Wireless Local Area Network) or a wireless WAN (WWAN: Wireless Wide Area Network) via a base station, or the Internet that uses a communication protocol such as TCP/IP (Transmission Control Protocol/Internet Protocol).

### [Exemplary Hardware Configuration of the Information Processing Device 100]

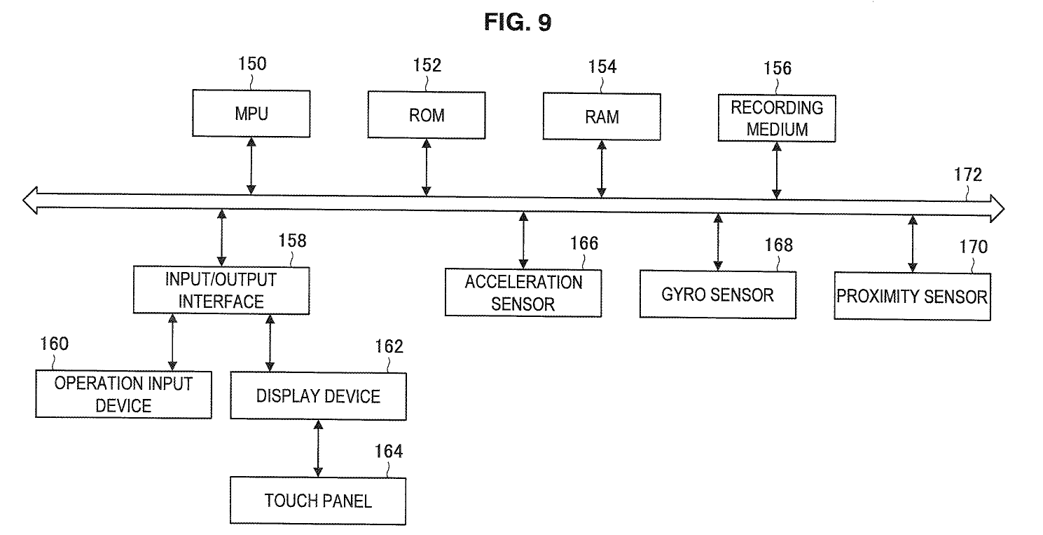

FIG. 9 is an explanatory diagram showing an exemplary hardware configuration of the information processing device in accordance with this embodiment. Herein, FIG. 9 shows an exemplary hardware configuration when the information processing device 100 functions as an operation device.

The information processing device 100 includes, for example, a MPU 150, ROM 152, RAM 154, a recording medium 156, an input/output interface 158, an operation input device 160, a display device 162, a touch panel 164, an acceleration sensor 166, a gyro sensor 168, and a proximity sensor 170. In addition, the information processing device 100 connects each component with a bus 172 as a data transmission channel, for example.

The MPU 150 includes an integrated circuit obtained by integrating various circuits for implementing an MPU and a control function, and functions as a control unit (not shown) for controlling the entire information processing device 100. In addition, the MPU 150 can also function as the processing unit 106 described below in the information processing device 100.

The ROM 152 stores control data such as programs and operation parameters used by the MPU 150, for example, and temporarily stores programs executed by the MPU 150, for example.

The recording medium 156 is a storage means of the information processing device 100, and functions as a storage unit (not shown). The recording medium 156 has an application or the like stored therein, for example. Herein, the recording medium 156 may be, for example, a magnetic recording medium such as a hard disk or nonvolatile memory such as flash memory. In addition, the recording medium 156 may be removable from the information processing device 100.

The input/output interface 158 connects the operation input device 160 and the display device 162, for example. Herein, the input/output interface 158 may be, for example, a USB (Universal Serial Bus) terminal, a DVI (Digital Visual Interface) terminal, a HDMI (High-Definition Multimedia Interface) terminal, or various processing circuits. It is needless to mention that the input/output interface 158 can connect to an operation input device (e.g., a keyboard or a mouse) serving as an external device of the information processing device 100 or a display device (e.g., an external display).

The operation input device 160 functions as an operation unit (not shown). In addition, the operation input device 160 may function as the second detection unit 104. The operation input device 160 is provided on the information processing device 100, for example, and is connected to the input/output interface 158 in the information processing device 100. The operation input device 160 may be, for example, a button, a direction key, a rotary selector such as a jog dial, or a combination of them.

The display device 162 functions as the second detection unit 104 together with the touch panel 164. The display device 162 is provided on the information processing device 100, for example, and is connected to an input/output interface 158 in the information processing device 100. The display device 162 may be, for example, a liquid crystal display or an organic EL display.

The touch panel 164 that can detect one or more operation positions is provided on the display device 162. The display device 162 and the touch panel 164 function as the second detection unit 104, for example, and detects a user operation on the user interface that can display information and can be operated by a user. Herein, the touch panel 164 may be, for example, a capacitive touch panel. However, the touch panel 164 in accordance with this embodiment is not limited thereto. For example, the information processing device 100 can have a touch panel with any given method that can detect one or more operation positions.

The acceleration sensor 166, the gyro sensor 168, and the proximity sensor 170 function as the first detection unit 106, and detects a movement of the information processing device 100 (i.e., an operation device).

The information processing device 100, with the configuration shown in FIG. 9, for example, performs a process in accordance with the aforementioned information processing method in accordance with this embodiment. Note that the hardware configuration of the information processing device 100 in accordance with this embodiment is not limited to the configuration shown in FIG. 9. For example, the information processing device 100 may have one or more GPS devices as the first detection unit 102. By having a GPS device(s), the information processing device 100 can identify the position of the information processing device 100 and can, by combining detection results of a plurality of GPS devices, identify the direction.

When the information processing device 100 does not function as an operation device, for example, that is, when the information processing device 100 detects each of a movement of an operation device (e.g., an external device) and a user operation on the basis of detection values or signals of various sensors transmitted from an external operation device, the information processing device 100 further includes a communication interface (not shown). In such a case, the information processing device 100 need not have the touch panel 162, the acceleration sensor 166, the gyro sensor 168, or the proximity sensor 170 shown in FIG. 9.

Herein, the communication interface (not shown) functions as a communication unit (not shown) for performing wire or wireless communication with an external device via a network (or directly). The communication interface (not shown) may be, for example, a communication antenna and an RF circuit (wireless communication); a LAN terminal and a transmitting/receiving circuit (wire communication); or the like. Note that the communication interface (not shown) in accordance with this embodiment is not limited to the aforementioned example, and may have a configuration supporting a network, for example.

Referring again to FIG. 8, an exemplary configuration of the information processing device 100 will be described. The first detection unit 102 serves a function of playing a leading role in performing a part of the aforementioned process (I) (detection process), and detects a movement of the operation device.

Herein, when the operation device to be detected is the information processing device 100, the first detection unit 102 detects a movement of the operation device (i.e., the information processing device 100) by having various sensors such as the acceleration sensor 166, the gyro sensor 168, or the proximity sensor 170, for example. Meanwhile, when the operation device to be detected is an external device, the first detection unit 102 detects a movement of the operation device (i.e., the external device) based on the detection values of various sensors of the external device received via a communication unit (not shown).

The second detection unit 104 plays a leading role in performing a part of the aforementioned process (I) (detection process), and detects a user operation on the user interface.

Herein, when the operation device to be detected is the information processing device 100, the second detection unit 104 detects a user operation on the operation device such as a button or a user operation (a touch operation) on the touch panel 164. Meanwhile, when the operation device to be detected is an external device, the second detection unit 104 detects a user operation on the external device based on a signal in accordance with a user operation on a user interface of the external operation device received via a communication unit (not shown), for example.

The processing unit 106 plays a leading role in performing the aforementioned process (II) (execution process), and performs a process based on a detection result obtained by the first detection unit 102 or a detection result obtained by the second detection unit 104. In addition, the processing unit 106, when, while performing a process based on the detection result obtained by one of the first detection unit 102 or the second detection unit 104, the detection result obtained by the other detection unit is detected, selectively changes the content of the process being performed based on the detection result obtained by the one of the detection units, based on the detection result obtained by the other detection result.

The information processing device 100, with the configuration shown in FIG. 9, for example, performs a process in accordance with the information processing method in accordance with this embodiment (for example, the process (I) (detection process) and the process (II) (execution process)). Thus, the information processing device 100 can improve the operability for the user with the configuration shown in FIG. 9, for example.

As described above, the information processing device 100 in accordance with this embodiment performs the process (I) (detection process) and the process (II) (execution process) as a process in accordance with the information processing method in accordance with this embodiment. The information processing device 100 detects different types of operations: a physical operation on the operation device and a user operation on the user interface (the process (I)), and performs a process corresponding to the detected operation (the process (II)). Accordingly, as the information processing device 100 allows a plurality of operations to be performed in parallel to allow a user to execute a plurality of processes at the same timing, it is possible to further improve the operability for the user.

The information processing device 100 not only performs a process corresponding to each of different types of detected operations, but also, when, while performing a process based on one of detection results, the other detection result is detected, selectively changes the content of the process being performed based on the one of the detection results (the process (II)). That is, using the information processing device 100, the user can control execution of processes in the information processing device 100 by combining different types of operations. Thus, the information processing device 100 can further improve the operability for the user.

Thus, the information processing device 100 can further improve the operability for the user.

In addition, as the information processing device 100 can perform a process corresponding to each of a physical operation on the operation device and a user operation on the user interface as described above, it is possible to provide the advantageous effects shown in (A) and (B) below, for example, to the user.

### (A) Improvement of the Operation Speed

Regarding a device that can be operated by one hand of a user, such as a smartphone, for example, there are cases in which one of a physical operation on an operation device or a user operation on the user interface is performed. When the information processing device 100 is applied to a device that can be operated by one hand of a user such as a smartphone, for example, both a physical operation on an operation device and a user operation on the user interface can be performed in parallel. Thus, when the information processing device 100 is applied to a device that can be operated by one hand of a user such as a smartphone, for example, the operation speed can be improved.

### (B) Provision of More Intuitive Operation System

There are cases in which, for example, objects other than selected objects are not very important, and there exists a request indicating that objects other than the selected objects be handled roughly. Such a request would be strong in a case in which, for example, only important photographs (an example of objects) should be collected and the other photographs should be discarded or viewed later. Using the information processing device 100 allows a physical operation on an operation device and a user operation on a user interface to be performed in parallel. Accordingly, the information processing device 100 can provide a user with an intuitive operation system that combines an important operation on the screen (an example of a user operation on the user interface) and a rough physical operation on the operation device.

Although the information processing device 100 has been described above as this embodiment, this embodiment is not limited thereto. This embodiment can be applied to various devices such as, for example, communication device like a portable phone or a smartphone, a video/music playback device (or a video/music recording/playback device), a game machine, a computer like a PC (Personal Computer).

### Program in Accordance with this Embodiment

Using a program for causing a computer to function as the information processing device in accordance with this embodiment (e.g., a program that can execute processes in accordance with the information processing method in accordance with this embodiment such as the process (I) (detection process) and the process (II) (execution process), the operability for the user can be improved.

Although the preferred embodiments of the present disclosure have been described in detail with reference to the appended drawings, the present disclosure is not limited thereto. It is obvious to those skilled in the art that various modifications or variations are possible insofar as they are within the technical scope of the appended claims or the equivalents thereof. It should be understood that such modifications or variations are also within the technical scope of the present disclosure.

For example, although the aforementioned description shows that a program for causing a computer to function as the information processing device in accordance with this embodiment is provided, this embodiment can also provide a recording medium having the program recorded thereon.

The aforementioned configuration is only exemplary, and naturally belongs to the technical scope of the present disclosure.

Additionally, the present technology may also be configured as below.
(1) An information processing device comprising:

a first detection unit configured to detect a movement of an operation device having a user interface that can be operated by a user;

a second detection unit configured to detect a user operation on the user interface; and

a processing unit configured to perform a process based on one of a detection result obtained by the first detection unit or a detection result obtained by the second detection unit,

wherein the processing unit, when, while performing a process based on a detection result obtained by one of the first detection unit or the second detection unit, a detection result obtained by the other detection unit is detected, selectively changes content of the process being performed based on the detection result obtained by the one of the detection units, based on the detection result obtained by the other detection unit.
(2) The information processing device according to (1), wherein the processing unit

determines if the detection result obtained by the other detection unit is related to an object that is a processing target of the process being performed based on the detection result obtained by the one of the detection units, and

changing, upon determining that the detection result obtained by the other detection unit is related to the object, the content of the process being performed based on the detection result obtained by the one of the detection units.
(3) The information processing device according to (1) or (2), wherein the processing unit, when, while performing a process based on the detection result obtained by one of the first detection unit or the second detection unit, the detection result obtained by the other detection unit is transmitted, selectively interrupts or stops the process being performed based on the detection result obtained by the one of the detection units.
(4) The information processing device according to any one of (1) to (3), wherein the operation device is the information processing device.
(5) The information processing device according to any one of (1) to (3), wherein the operation device is an external device.
(6) An information processing method comprising:

detecting a movement of an operation device having a user interface that can be operated by a user;

detecting a user operation on the user interface; and performing a process based on one of a detection result of the movement of the operation device or a detection result of the user operation,

wherein the step of performing the process includes, when, while performing a process based on one of the detection result of the movement of the operation device or the detection result of the user operation, the other detection result is detected, selectively changing content of the process being performed based on the one of the detection results, based on the other detection result.
(7) A program for causing a computer to execute:

detecting a movement of an operation device having a user interface that can be operated by a user;

detecting a user operation on the user interface; and

performing a process based on one of a detection result of the movement of the operation device or a detection result of the user operation,

wherein the step of performing the process includes, when, while performing a process based on one of the detection result of the movement of the operation device or the detection result of the user operation, the other detection result is detected, selectively changing content of the process being performed based on the one of the detection results, based on the other detection result.

The present disclosure contains subject matter related to that disclosed in Japanese Priority Patent Application JP 2011-157973 filed in the Japan Patent Office on Jul. 19, 2011, the entire content of which is hereby incorporated by reference.

What is claimed is:

1. An information processing device comprising:
a first detection unit configured to detect a movement of an operation device having a user interface that can be operated by a user;
a second detection unit configured to detect a user operation on the user interface; and
a processing unit configured to perform a process based on one of a detection result obtained by the first detection unit or a detection result obtained by the second detection unit,
wherein the processing unit, when, while performing a process based on a detection result obtained by one of the first detection unit or the second detection unit, a detection result obtained by the other detection unit is detected, selectively changes content of the process being performed based on the detection result obtained by the one of the detection units, based on the detection result obtained by the other detection unit.

2. The information processing device according to claim 1, wherein the processing unit
determines if the detection result obtained by the other detection unit is related to an object that is a processing target of the process being performed based on the detection result obtained by the one of the detection units, and
changing, upon determining that the detection result obtained by the other detection unit is related to the object, the content of the process being performed based on the detection result obtained by the one of the detection units.

3. The information processing device according to claim 1, wherein the processing unit, when, while performing a process based on the detection result obtained by one of the first detection unit or the second detection unit, the detection result obtained by the other detection unit is transmitted, selectively interrupts or stops the process being performed based on the detection result obtained by the one of the detection units.

4. The information processing device according to claim 1, wherein the operation device is the information processing device.

5. The information processing device according to claim 1, wherein the operation device is an external device.

6. An information processing method comprising:
detecting a movement of an operation device having a user interface that can be operated by a user;
detecting a user operation on the user interface; and
performing a process based on one of a detection result of the movement of the operation device or a detection result of the user operation,
wherein the step of performing the process includes, when, while performing a process based on one of the detection result of the movement of the operation device or the detection result of the user operation, the other detection result is detected, selectively changing content of the process being performed based on the one of the detection results, based on the other detection result.

7. A program for causing a computer to execute:
detecting a movement of an operation device having a user interface that can be operated by a user;
detecting a user operation on the user interface; and
performing a process based on one of a detection result of the movement of the operation device or a detection result of the user operation,
wherein the step of performing the process includes, when, while performing a process based on one of the detection result of the movement of the operation device or the detection result of the user operation, the other detection result is detected, selectively changing content of the process being performed based on the one of the detection results, based on the other detection result.
